(19) United States
(12) Patent Application Publication
(10) Pub. No.: US 2015/0302443 A1
(43) Pub. Date: Oct. 22, 2015

(54) LIMITED-CIRCLE SOCIAL MEDIA REWARDS

(71) Applicant: Steven Vu, Houston, TX (US)

(72) Inventor: Steven Vu, Houston, TX (US)

(21) Appl. No.: 14/257,138

(22) Filed: Apr. 21, 2014

(51) Int. Cl. G06Q 30/02; H04W 4/14; G06Q 50/12

(52) U.S. Cl. CPC G06Q 30/0214; G06Q 30/0231; G06Q 50/12; G06Q 30/0233; H04W 4/14

(57) ABSTRACT

A social media application allows a person to make a limited number of referrals to an entity. The entity keeps track of whether the referred people patronize the entity and awards credits to the person making the referral when a referred person patronizes the entity. Upon receiving a threshold credit value, the entity may reward the person making referrals.

### TECHNICAL FIELD

The present invention relates to the field of social media and rewards systems, and in particular to a system for providing referrals to a limited size circle of people.

### BACKGROUND ART

The use of social media in marketing campaigns has grown tremendously over the past several years. Companies provide pages on social media sites like Facebook, and encourage people to “like” their sites and to recommend the company to their friends. Sites like Yelp provide many different types of companies with a place where their customers can review and recommend (or express their dislike for) the company. But social media has become such a saturated market that information and opinions expressed in social media have become less effective. Many reviews of products and companies are widely considered to be by fake reviewers who are paid to make positive reviews. Every day people are inundated with “likes” and “stars” from people that they may not know at all. Therefore, the real reviews and positive comments are often lost in the overload of ads, coupons, and general misinformation.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram illustrating an infrastructure in which limited-circle referrals may be implemented according to one embodiment.

FIG. 2 is a block diagram illustrating a programmable device usable for deploying the limited-circle referral technique according to one embodiment.

FIG. 3 is a flowchart illustrating a technique for making a referral according to one embodiment.

FIG. 4 is a flowchart illustrating a technique for recognizing a referral that results in a referred person patronizing a business entity.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a computer system” can refer to a single computer or a plurality of computers working together to perform the function described as being performed on or by a computer system.

As used herein, the term “a computer system” can refer to a single computer or a plurality of computers working together to perform the function described as being performed on or by a computer system. Similarly, a machine-readable medium can refer to a single physical medium or a plurality of media that may together contain the indicated information stored thereon. A processor can refer to a single processing element or a plurality of processing elements, implemented either on a single chip or on multiple processing chips.

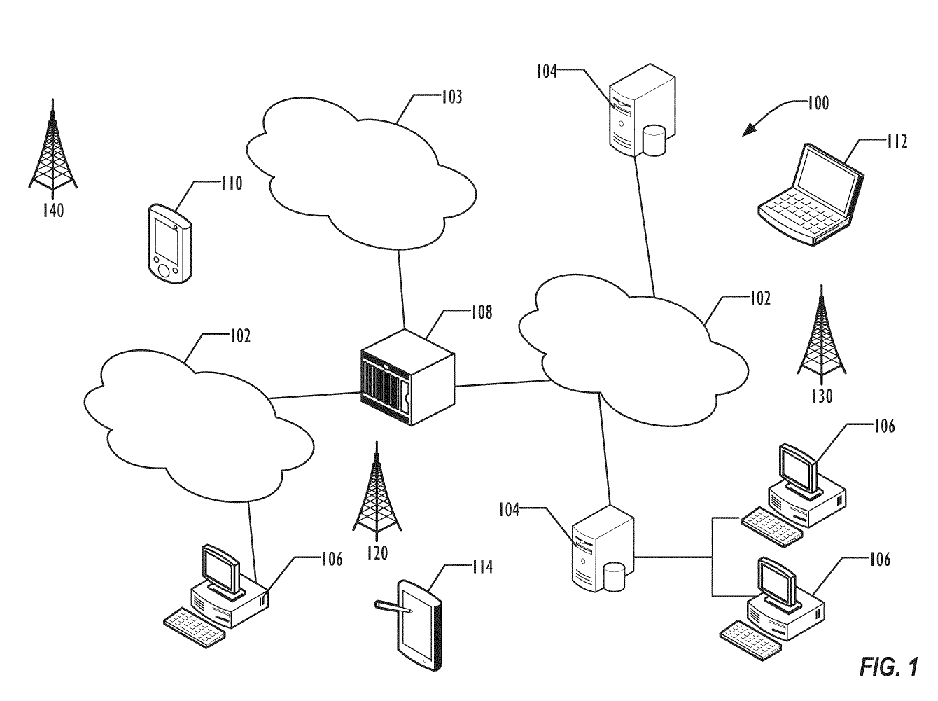

Referring now to FIG. 1, an example infrastructure 100 in which the techniques described below may be implemented is illustrated schematically. Infrastructure 100 contains computer networks 102. Computer networks 102 may include many different types of computer networks available today, such as the Internet, a corporate network, or a Local Area Network (LAN). Each of these networks can contain wired or wireless programmable devices and operate using any number of network protocols (e.g., TCP/IP). Networks 102 may be connected to gateways and routers (represented by 108), end user computers 106, and computer servers 104. Infrastructure 100 also includes cellular network 103 for use with mobile communication devices. Mobile cellular networks support mobile phones and many other types of devices. Mobile devices in the infrastructure 100 are illustrated as mobile phones 110, laptops 112, and tablets 114. A mobile device such as mobile phone 110 may interact with one or more mobile provider networks as the mobile device moves, typically interacting with a plurality of mobile network towers 120, 130, and 140 for connecting to the cellular network 103. Although referred to as a cellular network in FIG. 1, a mobile device may interact with towers of more than one provider network, as well as with multiple non-cellular devices such as wireless access points and routers 108. In addition, the mobile devices 110, 112, and 114 may interact with non-mobile devices such as computers 104 and 106 for desired services. In the following discussion, mobile device 110 is used as representative of all mobile devices.

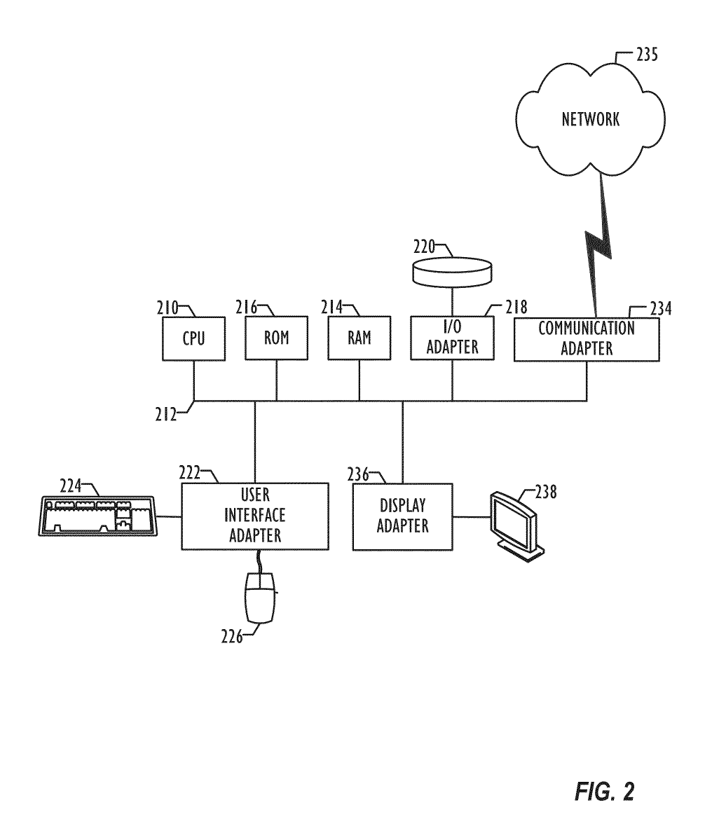

FIG. 2 shows a representative hardware environment that may be associated with the servers 104 and/or clients 106 of FIG. 1, in accordance with one embodiment. The figure illustrates a typical hardware configuration of a workstation in accordance with one embodiment having a central processing unit 210, such as a microprocessor, and a number of other units interconnected via a system bus 212. Although described as a system bus 212, any type of interconnect link may be used, including point-to-point links.

While FIG. 2 illustrates a programmable device with a single processor 210 for clarity of the drawing, the scope of the present invention is not so limited and any number of processing elements may be present. If more than one processing element is present, one or more of the processing elements may be an element other than a processor, such as an graphics processing unit (GPU), a digital signal processing (DSP) unit, a field programmable gate array, or any other programmable processing element, and the processing elements may be heterogeneous or asymmetric to each other. There can be a variety of differences between the processing elements in terms of a spectrum of metrics of merit including architectural, microarchitectural, thermal, power consumption characteristics, and the like. These differences may effectively manifest themselves as asymmetry and heterogeneity amongst the processing elements. In some embodiments, the various processing elements may reside in the same die package.

The programmable device shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, and/or other user interface devices such as a touch screen (not shown) to the bus 212, communication adapter 234 for connecting the workstation to a communication network 235 (e.g., a data processing network) and a display adapter 236 for connecting the bus 212 to a display device 238. Instead of a keyboard and mouse, other types of input devices, such as a touch screen, may be used. Although a single system bus is illustrated in FIG. 2 for clarity, multiple busses or links may be used, with some elements connected to different links with interconnects between the links.

The storage unit 220 may be any time of storage device, including hard disk drives, optical disk drives, flash or other solid-state storage devices, etc. The communication adapter 234 may be a wired or wireless adapter for connected to wired or wireless networks.

In one embodiment, the person making a referral (the “referrer”) does so through an application running on a mobile phone 110, such as a smart phone. The application running on the mobile phone 110 may communicate as needed with a server 104 that may be run either by the entity to which the referrer is referring another person, or by a separate entity that provides services to the entity that is the subject of the referral. Most commonly, a separate entity that provides referral services to multiple entities will handle the interactions between referrer, the person receiving the referral, and the entity that is the subject of the referral.

Most advertisers know that “word of mouth” is the most powerful form of advertising. What people hear from others that they know and trust is frequently a much more powerful incentive to encourage someone to patronize a business than any television, radio, print, or website advertisement or review information from people that are unknown and may not even exist.

Companies often try to encourage their customers to recommend others to patronize their business by rewarding customers by offering campaigns such as offering rewards, such as discounts or cash, to customers who convince others to try the company's products or services. But there are generally no controls over such renewals. A person with hundreds of friends on Facebook (who may know the person only tangentially) may post a recommendation there in hopes that others will take up the company's offer. However, the faceless nature of such recommendations is far from as powerful as individual recommendations.

The techniques below recognize that humans tend to operate in circles of friends, usually with very close friends in a small circle, less close friends in a larger circle, and acquaintances and business associates in an even larger circle. The closer the relationship, the more likely that a person's recommendation will prove helpful in encouraging the person given a referral to follow up on that referral and patronize the referred company.

At the same time, incentivizing the referrer to make recommendations is helpful. A person is more likely to make a referral if the referral may result in a reward or an increased likelihood of a reward. That is why referrers are often offered rewards for their referrals to thank faithful referrers.

The techniques described below offer a way to allow companies to encourage referrals where referrals are the most powerful: to people known by the referrers. The referrer makes referrals to a limited circle of friends. As those friends patronize and spend money at the company's business, the referrer earns credit for those successful referrals. In addition, the referred person may keep the chain of referrals going by making their own referrals to their circle of friends, earning their own credit from the company. Finally, to reward the referrers, the company allows the referrers discounts or free products or services.

In addition, embodiments disclosed below limit the number of people to whom a referrer can make a referral through the disclosed system, so that the referrer cannot give referrals to an overly large (and probably less connected to the referrer) group of people. Similarly, the referrer only receives credits when their referrals result in business from the person to whom the referral is made. Thus, a referrer who can only make a limited number of referrals is incentivized to be selective in making the referrals, helping ensure that only those with the highest likelihood of success receive referrals. Thus, by design, the disclosed techniques cultivate intimate, value-added referrals for a business entity among close-knit groups.

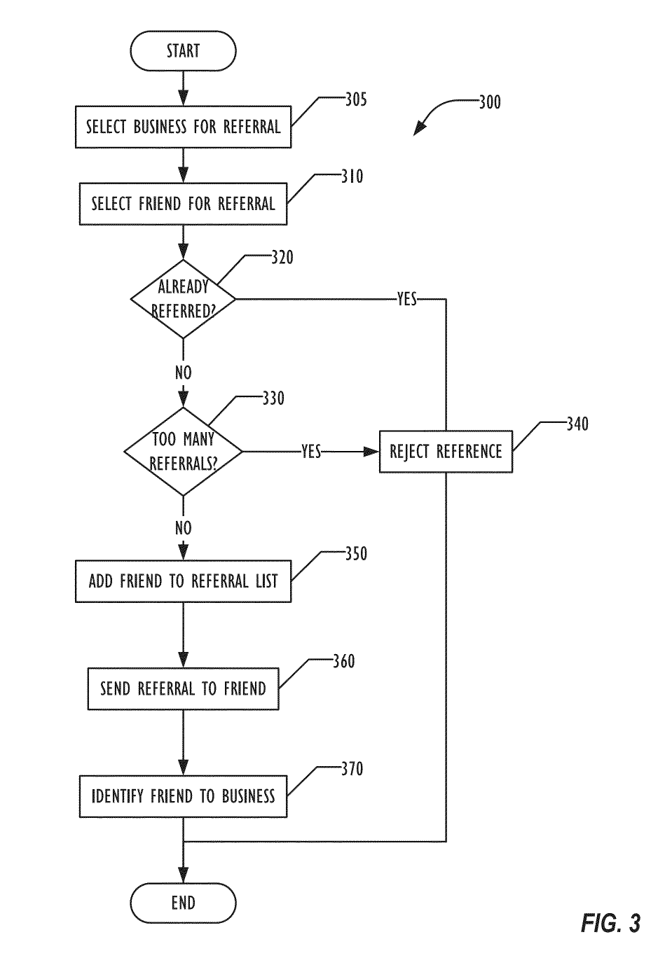

FIG. 3 is a flowchart illustrating a technique for making a referral in a limited-circle social media setting. In block 305, the referrer selects a business for the referral. In block 310, the referrer selects a friend to whom a referral is to be made. Although the term “friend” is used in the following description, the term is not limited to any particular type of friend, and does not depend upon the friend having a “friend” relationship in any general-purpose social media application, such as Facebook. The referrer identifies the selected friend in a limited-circle social media application, such as an app running on the referrer's smartphone. In one embodiment, the application may provide a list of friends to select from when making the referral. Various embodiments may require any desired collection of information about the friend when making the selection in addition to the friend's name. Preferably, the friend information includes contact information such as an email address, an instant messaging identifier, or a phone number for text messages.

In block 320, the app determines whether the selected friend has already received a referral. The app may keep a local list of referrals or communicate with a server 104 that maintains such a list. Although described as a “list,” the information about previous referrals may be maintained in any form desired, such as entries in a database, in addition to simple lists. If the referral information is maintained by a server, the app may send a request to the server to allow the referral, and receive a response indicating whether the referral was accepted. If the person has already received a referral, then in block 340 the referral may be rejected.

If the selected friend has not already been referred to the business entity selected in block 305, then in block 330 a check is made to determine whether new referral would exceed a threshold maximum number of referrals. As with the check of block 320, this may be performed locally to the app or by the server to which the request to make a referral is sent. If the referral threshold would exceed the threshold number of referrals, then in block 340 the referral may be rejected. In one embodiment, the threshold is 10 referrals, so that referrer may not refer more than 10 friends to the business entity.

If the referral is rejected in block 340, the referral process terminates.

If the referral is accepted, then in block 350 the friend may be added to the list of referrals from the referrer to the business entity. Separate lists may be maintained for different business entities. In one embodiment, the business entities are subscribers to a referral service that provides the app and the backend server system for managing the referrals.

The friend may then be sent the actual referral in block 360. The referral may be any type of desired communication. In one embodiment, the referral may be a notification in the social media app that the person has received another referral. In one embodiment, the referral takes the form of an email message from the referrer to the friend, with a message encouraging the friend to patronize the business entity. In another embodiment, an instant messaging message or text message may be sent to the friend. In yet another embodiment, a postal mail message may be mailed to the friend. In some embodiments, the content of the message may be provided by the referral app or server. In some embodiments, the referrer may be allowed to select a message or to provide custom referral text to include in the referral message, in addition to or instead of a standard reference message, making the referral more personal. In some embodiments, the referral message may provide a coupon or other information to allow the person receiving the referral to receive a discount or other incentive for following up on the referral and patronizing the business entity.

In one embodiment, the social media app may provide information regarding any referrals that have been made to a user of the social media app, including information about the person making the referral. In one embodiment, the social media app may provide other information about referrals, such as a map showing the locations of referred business entities, which may be limited to locations within a predetermined distance of the social media app user.

In block 370, the referral system, typically the server 104, may also send a message to the business entity identifying the person receiving the referral. The business entity may then choose to make an additional communication to the friend receiving the referral, further incentivizing the friend to patronize the business because of the referral.

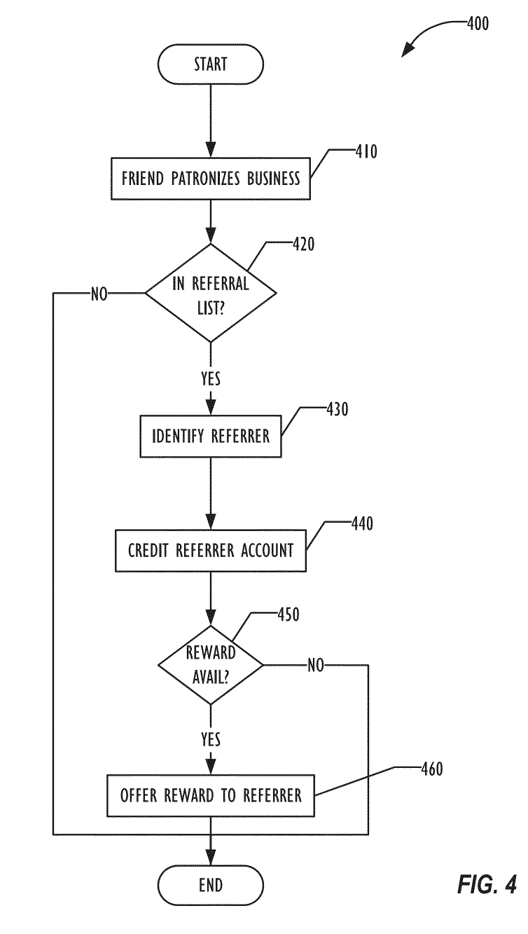

FIG. 4 is a flowchart illustrating a technique 400 for processing a person following up on a referral and patronizing the business to which the person was referred. In block 410, the friend patronizes the business. This may be having a meal at a restaurant, buying a product from a retailer, using a service of a service provider, or any other way in which a person may take advantage of the products or services of the business entity to which they were referred.

In one embodiment, the person identifies himself or herself by providing information to the limited-circle social media app about a receipt from the business as evidence of having patronized the business. Any desired information may be used, such as a receipt number or any other unique information for identifying the person. Other information may be provided, such as the amount of the purchase. In one embodiment, a copy of the bill or invoice may be uploaded in the social media app. In block 420, the referral system determines the identity of the person patronizing the business, and determines whether that person has received a referral from anyone. If the person was not referred to the business, the referral system finishes processing the transaction.

In one embodiment, the business entity may be notified of the referral system processing an indication of patronage by a referred person and may be given an opportunity to approve or disapprove granting credits or points to the referrer.

If the person was referred to the business, then in block 430 the referrer is identified. In some embodiments, multiple people may have referred a person to a business entity, and each referrer may gain the benefit of the reference. In other embodiments, only one person may gain the benefit of the reference, typically the first person to make the referral. However, in some embodiments, the most recent person to make a referral gains the benefit, because that referral is less stale.

In block 440, an account for the identified referrer may be credited with points or other forms of credit. In some embodiments in which multiple referrers may be credited, each referrer may receive the same credit. In other embodiments, different referrers may receive different credit for the referral. For example, a single credit amount may be authorized for a referral and each referrer may split the single credit amount. In another example, the referral system may elect to credit different referrers with different credit amounts, such as crediting a more recent referrer more than a less recent referrer, or crediting a referrer whose referrals have proven more successful in encouraging friends to patronize the business more than a referrer with less referral success. Any desired way of crediting multiple referrers may be used.

In some embodiments, the number of points or credits received may depend on the amount of the purchase made by the referred person. Thus if one referred person made a large purchase and another referred person may a small purchase, such an embodiment would award more points or credits to the referrer for the large purchase than for the small purchase.

In some embodiments, the number of points or credits awarded to the referrer may depend on the type or location of the business entity. For example, one business entity may set a credit rate based on a purchase level at 20 points per dollar, while another business entity may set a credit rate at 50 points per dollar. A business at one location may make different credit rate settings than a business at a different location. Alternately, business may define different credit rates based on the type of purchase.

In block 450, the referral system may determine that the account of a referrer has accrued sufficient credit that a reward is available for the referrer. Where a single reward is the only reward available, a fixed threshold may be used. Where multiple rewards may be available, each reward may have a different reward threshold to qualify for the reward. Rewards may be any type of reward that the business entity may wish to offer. In some embodiments, the rewards are directly offered by the business entity receiving the referral. In other embodiments, the rewards may be offered by the referral system operator, based upon criteria selected by the business entity that subscribes to the referral service. In some embodiments, referrals may be cash awards, discounts, or free items. For example, a restaurant may offer a free meal as a reward.

If a reward is available, in block 460 the referrer may be offered the reward. The reward offer may be made in a monthly or other periodic statement, or may be offered immediately through the referral app. If the reward is taken, then the referrer's account may be debited for the amount corresponding to that reward. Where multiple rewards may be available, the referrer may be offered a chance to choose between rewards for which the credit amount in the referrer's account qualifies. In some embodiments, the person using the social media app can use it to request account status information from the server, such as credit accruals, and what rewards may be available based on the credit accruals.

In one embodiment, rewards may be made on the spot. For example, social media users having accrued points or credits may go to a restaurant because of the credits they have earned from that restaurant. When they finish their meal, they may advise the waiter of their identification in the limited-circle social media app, and the number of credits they wish to use. The waiter may then access the social media system, identify the customer, and approve use of the points as a reward. The system may then reduce the number of points in the account of the person patronizing the business and notify the social media user that their account has been debited accordingly. The system may then tell the waiter how much of a discount should be taken off the customer's bill.

By providing a reward-based limited circle social media application for making referrals, a business may incentivize its faithful customers to make referrals to people that are likely to act on those referrals, making the referrals more valuable than a broadcast to a large number of people that the referrer “likes” a company or a review on a review website. Thus, the social media app can leverage the enhanced value of word of mouth referrals in a modern social media type setting.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A machine-readable medium, on which are stored instructions, comprising instructions that when executed cause a machine to:
receive a request to send a referral of an entity to a person;
determine a count of referrals of the entity from the referrer;
reject the request if the count is greater than or equals to a threshold number;
send the referral to the person if the count is less than the threshold number;
recognize the person has patronized the entity;
award credits to the referrer responsive to the recognition; and
offer a reward to the referrer if the referrer has accumulated sufficient credits for the reward.

2. The machine-readable medium of claim 1, wherein the entity is a restaurant.

3. The machine-readable medium of claim 2, wherein the reward is a meal at the restaurant.

4. The machine-readable medium of claim 1, wherein the reward is a discount for the referrer at the entity.

5. The machine-readable medium of claim 1, wherein the threshold number is 10.

6. The machine-readable medium of claim 1, wherein the instructions that when executed cause the machine to send the referral to the person comprise instructions that when executed cause the machine to:
send the referral as an email message.

7. The machine-readable medium of claim 1, wherein the instructions that when executed cause the machine to send the referral to the person comprise instructions that when executed cause the machine to:
send the referral as a text message.

8. The machine-readable medium of claim 1, wherein the referral choose to the person comprises a coupon for use with the entity.

9. The machine-readable medium of claim 8, wherein the instructions that when executed cause the machine to recognize the person has patronized the entity comprise instructions that when executed cause the machine to:
receive a notice from the entity responsive to use of the coupon by the person.

10. The machine-readable medium of claim 1, wherein the instructions further comprise instructions that when executed cause the machine to:
authenticate the referrer.

11. A method, comprising:
receiving a request for a referral of an entity to a person in an application executing on a mobile device;
sending the referral to the person if no more than a threshold number of referrals to the entity have been sent from the application; and
receiving a notice of a reward from the entity responsive to a threshold number of referred persons patronizing the entity.

12. The method of claim 11, wherein the threshold number of referrals to the entity is 10.

13. The method of claim 11, wherein sending the referral comprises:
sending information to a server regarding the referral request; and
receiving information from the server indicating whether the referral is allowed.

14. The method of claim 11, wherein sending the referral comprises:
sending an email to the person.

15. The method of claim 11, wherein sending the referral comprises:
sending a message and a social media application.

16. The method of claim 11, wherein the reward is a discount at the entity.

17. The method of claim 11, wherein the entity is a restaurant and the reward is a free meal at the restaurant.

18. A machine-readable medium, on which are stored instructions, comprising instructions that when executed cause a mobile device to:
receive a request to refer an entity to a person;
determine whether a referral threshold has been met;
send the referral to the person if the referral threshold has not been met; and
receive a notice of a reward from the entity responsive to a threshold number of referred people patronizing the entity.

19. The machine-readable medium of claim 18, wherein the instructions that when executed cause the mobile device to determine whether a referral threshold has been met comprise instructions that when executed cause the mobile device to:
send information to a server associated with the request to refer the entity to the; and
receive an indication from the server whether the referral threshold has been met.

20. The machine-readable medium of claim 18, wherein the instructions further comprise instructions that when executed cause the mobile device to:
authenticate with a server.

21. The machine-readable medium of claim 18, wherein the instructions that when executed cause the mobile device to receive a notice of reward comprise instructions that when executed cause the mobile device to:
request information from a server regarding accumulated credits for referrals resulting in a person patronizing the entity; and
request a reward from the server responsive to the accumulative credits achieving a reward threshold.
